(19) United States
(12) Patent Application Publication
(10) Pub. No.: US 2018/0117613 A1
(43) Pub. Date: May 3, 2018

(54) RESPONSIVE FLUID DISPERSION FOR CONTROLLED FOG AND MIST

(71) Applicants: Arthur J. Zito, JR., Swampscott, MA (US); William R. Zito, Millersville, MD (US)

(72) Inventors: Arthur J. Zito, JR., Swampscott, MA (US); William R. Zito, Millersville, MD (US)

(21) Appl. No.: 15/568,054

(22) PCT Filed: Jan. 20, 2016
(86) PCT No.: PCT/US16/14198

§ 371 Date: Oct. 20, 2017

Related U.S. Application Data
(60) Provisional application No. 62/106,199, filed on Jan. 21, 2015.

(51) Int. Cl. B05B 12/02; B05B 1/02; B05B 9/00; B05B 9/04; B05B 12/00; B05B 12/12; B05B 13/00

(52) U.S. Cl. CPC B05B 12/02; B05B 1/02; B05B 9/002; B05B 13/005; B05B 9/007; B05B 12/006; B05B 12/12; B05B 9/04

(57) ABSTRACT

An apparatus unit that adjusts fluid dispersion in response to an independent variable such as an environmental factor, to optimize the drizzle, mist or fog effect by suspending fluid droplets of a specific size in a gas. A preferred embodiment is a solar powered pump, self-contained within a buoy over a coral reef, for the purpose of providing enough mist during the sunniest time of the day to reduce coral bleaching. The unit provides for sensing and measurement of the environment, then adapting the dispersion for optimum effect. The unit can provide proportional response, for example to deliver 100% misting during the most extreme periods of sunshine and 50% mist during a typically sunny time and no mist during a cloudy day. Several like or compatible units may be organized as a system for a more efficient effect or blanket effect over a wider domain and for a longer duration.

### FIELD OF INVENTION

This invention relates to systems and methods to disperse fluids in response to an independent variable such as water temperature or soil moisture or the amount of sunlight. The system and methods can be used to manage a local environment such as a coral reef or golf course, but can also be applied to small local environments such as a bird bath or swimming pool, or expanded into a network covering a coastline.

### BACKGROUND OF THE INVENTION

The world is experiencing more extreme weather effects. Water, air and sunlight are almost always significant factors causing extreme weather and also impacting human populations, plants and animals and the natural environment in general. While there is debate as to the priority of contributing factors, man-made or natural, there is no doubt that the contributions of various causes are cumulative: that is, an increased deviation to one causal factor will increase the likelihood and severity of weather events, and may be the critical tipping point for a catastrophic environmental change even if the relative contribution of that factor was small. Therefore it is beneficial to search all possible solutions to reduce the effects of contributing factors to this extreme weather.

The decay of coral reef formations has been attributed to sun bleaching, water temperature, salinity and pH, and shifts in the population of predators and cleaning species, among other factors. In one study, “The 27-Year Decline of Coral Cover on the Great Barrier Reef and Its Causes,” by Glen De'ath et al, the authors summarized, “Based on the world's most extensive time series data on reef condition (2,258 surveys of 214 reefs over 1985-2012) we show a major decline in coral cover from 28.0% to 13.8% (0.53% y−1), a loss of 50.7% of initial cover. Tropical cyclones, coral predation by crown-of-thorns starfish (COTS), and coral bleaching accounted for 48%, 42%, and 10% of the respective estimated losses . . . ” and concluded this summary, “strategies can, however, only be successful if climatic conditions are stabilized, as losses due to bleaching and cyclones will otherwise increase.” In an article “Mapping the Decline of Coral Reefs” by John Whier, the author wrote, “The latest reports state that as much as 27 percent of monitored reef formations have been lost and as much as 32 percent are at risk of being lost within the next 32 years.” In another article, “South Florida Coral Reefs In ‘Extremely Alarming’ Decline” by Robert Nolin, the author states, “A recent report by an international group of scientists concluded that coral reef growth, especially reefs in shallow water like that offshore South Florida, has declined by as much as 70 percent.” Considering the interdependence of life on earth to salt water coral formations, this erosion has been put forth by scientists as a crisis for our future existence and health.

The interaction, balance and transformation of a coral reef is complex, and the scientific study even of individual factors such as sunlight is rather recent, due in part to the difficulty of measuring aspects in a sub-sea region. The term “sun bleaching” is generalized to explain the white color of a dying reef formation, which is likely caused by several factors of temperature, pH, and others listed, and not singularly parallel to what is termed sunburn. But the effects of direct sunshine on temperature for an ocean reef have been proven. In “The physiological response of reef corals to diel fluctuations in seawater temperature” published by Hollie M. Putnam and Peter J. Edmunds, the authors summarize in the abstract, “the effects of” fluctuating temperatures on tropical scleractinian corals arose when diurnal warming (as large as 4.7° C.) was detected over the rich coral communities found within the back reef of Moorea, French Polynesia. The authors explain in the article (p. 217) that “underwater temperature fluctuates rapidly (i.e., up to ˜5° C. in <24 h) throughout the Florida Keys, the Bahamas, St. Croix, Belize, and Bonaire (Leichter et al, 2006), largely as a result of diurnal warming in shallow water (10 m), and tidal forcing and internal waves at greater depths (20-30 m).” In another study, “The effects of a variable temperature regime on the physiology of the reef-building coral Seriatopora hystrix: results from a laboratory-based reciprocal transplant” published by Anderson B. Mayfield et al., the authors summarize, “To understand the effects of global climate change on reef-building corals, a thorough investigation of their physiological mechanisms of acclimatization is warranted. However, static temperature manipulations may underestimate the thermal complexity of the reefs in which many corals live. For instance, corals of Houbihu, Taiwan, experience changes in temperature of up to 10° C. over the course of a day during spring-tide upwelling events.” In a third study, “Characterization of the ASHEPOO-COMBAHEE-EDISTO (ACE) Basin, S. C.,” published by E. Wenner et al., the authors explain, “Diurnal variation in temperature was evident with warmest temperatures occurring during the time interval of 1300-1800 hrs for each month at both sites. This diel variation in temperature is illustrated for Big Bay Creek. (chart provided below)”

In yet a fourth study, “Dramatic Variability of the Carbonate System at a Temperate Coastal Ocean Site (Beaufort, N.C.) is Regulated by Physical and Biogeochemical Processes on Multiple Timescales,” by Zackary I. Johnson et al., the authors noted “short-term spikes in the acidity of the estuary were driven by changes in temperature, water flow, biological activity and other natural factors . . . .”

Other trends include an increasing demand from the multiplying human population for fresh water, movement of water and purification of water, all simultaneous with a depletion of water stores from key regions and unpredictable climate impact to water conditions. Consider for the U.S.A. that California is mandating water rationing and regulations that impact the farmer and homeowner, but must be balanced to every business entity such as a golf course or manufacturing facility. The ability to provide water where it is needed, even if from a water source that would be considered remote or inaccessible prior to this invention, or to mitigate the growing drought conditions can have enormous benefit.

### DESCRIPTION OF PRIOR ART

Many methods exist for irrigation by sprinklers and sensors, or for desalinating water by evaporation or by reverse osmosis through porous membranes. Each of these systems seeks to deliver a prescribed quantity or moisture level through direct supply of water. For example, Campbell et al.'s U.S. Pat. No. 8,751,052 discloses a method to monitor soil moisture to set a threshold for irrigation, and would direct standard methods of flow irrigation. Campbell et al.'s U.S. Pat. No. 8,682,493 describes a plurality of profiles of moisture levels, salinity and temperature but would link these to common irrigation systems. As another example, Magro et al.'s U.S. Pat. No. 8,682,494 discloses methods to measure soil conditions such as salinity, temperature or moisture to prescribe direct action, and relies on common irrigation methods for that action.

In terms of desalination, Deutsch et al's U.S. Pat. No. 5,348,622 discloses a solar powered water purification system locating evaporating, condensing and distillate collecting chambers underground, and then capturing pure water and discharge. In another example, Voutchkov's U.S. Pat. No. 7,749,386 discloses apparatus to purify water by co-locating with a power plant to heat feed water and using reverse osmosis membrane filtration, and outputting a product water of less salt and an unusable water product with more salt. For another example, Thiers discloses in U.S. Pat. No. 8,771,477 B2 systems for water purification employing a preheater, degasser, evaporation chambers and demisters. For another example, Sparrow et al's U.S. Pat. No. 8,857,798 B1 discloses apparatus to concentrate solutions using evaporation. In another example, Keeton's U.S. Pat. No. 8,529,764 discloses adding a microbial treatment into air bubbles as it aerates a body of water.

An obstacle to current desalination methods is the energy cost to produce and the cost and equipment to transport fresh water to populated areas. A system that could move bulk quantities of water, partially desalinated and therefore usable, would reduce or replace such desalination systems.

One drawback is that such systems cannot keep pace with climate change. What was previously a need to add moisture intermittently during dry spells has become a constant demand for watering and at increasing cost per gallon or respective unit of measure. There exists a need to supply bulk quantities of moisture and which could collaborate with existing systems to regulate the end result more finely and efficiently.

Another drawback of current machines that create mist and fog is that the controls are typically an on/off switch, a timed delay function or a variable speed that provides partial dispersion. Control systems exist for other systems to measure the amount of fluid, humidity or temperature directly where that fluid, humidity or temperature will be applied in a concentrated quantity. For example, Evett et al.'s U.S. Pat. No. 8,924,031 describes the use of plant canopy temperature measurements to direct a controllable irrigation system. Another example is Fadell et al's U.S. Pat. No. 8,924,027 B2, which discloses an HVAC system to measure room temperature and humidity and automate the circulation of heated, cooled and/or humidified air. None of these systems has as an object to suspend moisture in the air for a temporary period greater than would occur for water falling at terminal velocity but not suspended indefinitely. To do so would require dispersion of fluid droplets of a particular size. To consistently disperse fluid in droplets of a particular size requires at least one adjustment based on at least one independent variable such as an external environmental factor.

Current systems disperse droplets outside of this range. The purpose of irrigation systems to utilize large droplets is to ensure the fluid will fall to the earth and not be lost to evaporation. The purpose of theatrical fog machines or recreational misters is to minimize the size of droplets and ensure the fluid will remain suspended for as long as possible or entirely, to create a visual theatrical effect and prevent mold growth, or until a person passes part of their body into the mist to receive moisture directly.

An independent variable is a factor, condition, object, action, event or change that exists or acts separately from the model or method of other variables proposed or measured. In a statistical or mathematical model, we measure the group of “other” variables that are dependent or affected by the independent variable. If we set up a matched control group where the independent variable is held steady while our test group changes the independent variable, or if we measure the group of dependent variables before and after a state change for the independent variable, this can measure the accuracy and effectiveness of a model. For this invention, our independent variable is defined as a factor, condition, object, action, event or change that occurs or acts separately from the apparatus and separately from the fluid that will be dispersed. When dispersing water, the external water vapor pressure is an independent variable that affects whether a droplet size will create fog or mist or drizzle.

One variable that affects the droplet size of fluids is the pressure from the pump or device that forces fluid through the nozzle. Another variable to control the size of fluid droplet is the diameter of a spray nozzle used to disperse the fluid. To change the diameter of the nozzle according to relative humidity would more precisely ensure the misting effect for the current environmental conditions and as those conditions change. Current machines do not have a method to modify the pump or nozzle based on relative humidity or to automatically adjust the pump or nozzle to deliver the optimum size droplets for the objective duration. Other variables that affect fluid droplet size and dynamics are the shape and direction from the nozzle.

None of the systems provide an apparatus that responds to environmental sensors with a proportionate dispersion of mist, fog or haze into the air as opposed to direct irrigation. None of the systems adjust a nozzle together with the fluid pressure in response to independent variables, such as environmental stimuli, to disperse mist, fog or haze as opposed to direct irrigation. None of the existing systems seek to mitigate environmental conditions by affecting the amount of sunlight in an area. None of the systems work together with natural forces such as wind to move large quantities of water.

### SUMMARY AND OBJECTS OF THE INVENTION

In general, the apparatus of the present invention comprises a sensor, a processor, a water pump and a nozzle of an aperture to disperse fluid droplets of a particular range of sizes. The preferred droplets are of a size that will remain suspended in a gas for a longer duration than would occur for larger drops to fall at terminal velocity back to the level of the apparatus. The preferred droplets are also of a size that will not evaporate into the gas and will not remain suspended in the gas indefinitely. The preferred suspension of droplets is actually a percentage of fluid or droplets in the mixture of the preferred size range; the behavior of fluid droplets can be complex when suspended in a gas as the shapes distort from gas pressure pushing unequally on the bottom, sides or top of the droplet as it falls due to gravity, and from droplets separating into smaller droplets due to such distortion or collision. A seminal publication defining the size of rain droplets and providing empirical rates for falling velocity was written by H. W. Lull of the U.S. Dept. of Agriculture:

The preferred result is to have 70% of the droplets between the size of 0.1 millimeters (median size of mist droplets that remain suspended) and 0.96 millimeters (median size of drizzle droplets that fall with gravity). The preferred result is to have 30% of droplets of the fluid dispersed to remain suspended in a gas mixture for a time greater than would elapse if the droplets fell at terminal velocity by force of gravity but also to have more than 30% of the droplets return to level of the source of fluid or an adjacent area, and not remain suspended indefinitely if unimpeded. To deliver the preferred droplet size, overall plume size and behavior of the dispersed fluid, key factors are nozzle size, pump pressure, and surrounding relative humidity, and secondary factors are nozzle capacity and shape design. On average, the preferred nozzle size will be greater than 1.0 mm diameter and less than 3 mm at a fluid pressure of 1000 psi. For comparison, commercial misters will use a nozzle size up to 1 mm at 1000 psi while commercial agricultural irrigators will use nozzle size as small as 4 mm at 1000 psi, and commercial cleaning or cutting water jets will use nozzle size smaller than 0.5 mm at 30,000 or more psi.

A preferred embodiment uses solar panels to power a pump that sprays sea water directly into the air, along with a computer to determine the rate of the pump based on the amount of sunlight. An alternate embodiment could derive power from at least one of natural phenomena that include sunlight, wind, tide, wave, water current or earthquake by utilizing equipment to convert the natural energy into kinetic or electric power. An alternate embodiment may use at least one of natural phenomena that include sunlight, wind, tide, wave, water current or earthquake as the independent variable to be measured. In this embodiment, all of the electrical components are sealed with a plastic housing, the plastic being clear on top of solar panels but not necessarily clear below the water line. The plastic housing is durable to withstand accidental impact from watercraft or other objects. The buoy is balanced with heavier equipment in the bottom to keep the pump submerged, but the buoy is also tethered by rope and anchor chain to the bottom of the ocean and that retains the buoy in a generally upright position regardless of wave or wake. A current, common practice is for a series of mooring buoys to be anchored at the rim of a reef, enabling a less intrusive method for dive and tourist boats to regularly visit the reef area without repeatedly dropping anchors that would otherwise damage the coral. To start, each of these apparatus buoys would replace an existing mooring buoy for no incremental impact to the reef. The buoy can include communications equipment to provide a short range homing beacon, and can also receive a standard short range signal from an approaching boat to suspend the pump activity. This permits tour and dive boats to tie to the buoy. The computer equipment can log activity of the pump and can log visits identified by individually approved boats, can transmit such log information remotely to an authorized receiving station, and where this information can be used to manage the location and even tax or fine craft for use or unauthorized use of the area. The presence, proximity or motion of any transportation vehicle or moving device can serve as an independent variable to be measured and send a signal to adjust the apparatus. More specifically, the presence, proximity or motion of any transportation vehicle or moving device can be detected and cause an interrupt to selectively activate or deactivate the entire apparatus unit or part of the apparatus unit. A similar utility can be produced and programmed to detect creatures and organisms, their movement, color, size, speed or species, as examples, and then selectively activate or deactivate the entire apparatus unit or parts of the apparatus unit. Other water conditions or weather information can be logged and received, thus communicated to interested visitors, scientists or environmentalists. The log and power unit, including equipment for power conversion and storage such as battery, can be used to store power and information for activation or deactivation at a later time that is optimal and to use predictive modelling to set the decision protocol to disperse droplets.

The preferred embodiment measures water temperature and uses the solar panel energy output to measure sunlight. An alternative embodiment can measure the amount of sunlight or salinity directly, and can receive signals from submerged sensors that measure water temperature, salinity, pH, creature count or activity, and the amount of sunlight at the submerged location of a coral reef, then integrate these measurements with the measurement of the independent variables to determine, analyze or assess the direct effect of the buoy apparatus. There are many ways to adjust the apparatus and the terms “adjust” or “adjustment” includes one or more of activating, deactivating, turning, rotating, spinning, or otherwise changing the direction of, increasing the speed of or power of the pump or pressure mechanism, increasing the pressure within or the aperture of a nozzle. By grouping a series of buoys along a key reef or oriented with prevailing winds, it is possible to optimize the protective effect of the water mist and to measure the effect of the system. An alternative embodiment uses a system of networked apparatus buoys, each also equipped with wind vanes that are now commonly integrated with anemometers to measure wind direction and speed. The networked apparatus buoys selectively activate the buoys in a position where the mist plume of each would be expected to carry over the reef location, and deactivate buoys in a position where the mist plume of those buoys would be unlikely to carry over the reef location. The system of apparatus units is networked together with communication and processing. Such a buoy or system of buoys would be especially relevant to protected dive sites such as sunken ships or to national parks and nature preserves. The intent for the apparatus or the system of apparatus units is to reduce the amount of sunlight reaching the fluid surface within an area where at least 50% of the fluid falls.

The unit provides for intermittent operation according to a range of conditions when its effect is needed the most, therefore making the unit more efficient and the benefit more targeted. The unit may be self-powering by use of solar panels, wind or current based generators, and store such power generated in batteries for use during optimal periods of time. The unit may be self-contained, so that it can be self-controlled and be used in more remote places or separated from man-made structures, power sources or monitoring and control. The apparatus unit in this embodiment is buoyant and able to be left unattended in the water or a fluid. The unit may have features, measuring sensors and programming that enable the unit to be more acutely responsive to environmental factors. The unit is automatic but may add manual or remote controls and communications that permit additional actions, reprogramming or data collection by human intervention.

In an alternative embodiment, the apparatus uses a higher pressure pump with the 3 mm nozzle size to extend a larger plume more consistently over time across a larger area. This embodiment could move a large quantity of water from a natural source or man-made capture of rainwater to a land area for support of irrigation. An application of this embodiment is to subsidize the irrigation of a golf course adjacent to an ocean or lake with favorable prevailing winds. The apparatus placed in water would sense an independent variable such as soil moisture in a land area or location adjacent to or separate from where the apparatus is located. The adjacent land area is also separate from where the dispersed fluid would fall by the force of gravity alone, as the embodiment would rely on wind to carry the water from the area of the apparatus to the land area. The intent is to disperse fluid of sufficient height and droplet size that at least 10% of the fluid falls to the area adjacent to the source fluid. Another application of this embodiment could stabilize climatic changes to large, coastal watershed regions. Water must be thrown at least 15 feet into the air to gain oxygen before falling back to a body of water, and typical aerators are used for confined area fish farms. The invention can be critical to provide aerated water more efficiently over a larger area such as stagnant lakes or swamp areas. Such a device can be beneficial to activate when one or more independent variables is not currently within a set range or when external power is not currently available.

It is therefore an object of the invention to disperse fluid in droplets of a particular size through at least one adjustment based on at least one independent variable such as an external environmental factor.

It is a further object of the invention to adjust the dispersion, duration and rate of flow for droplets between 0.1 mm and 0.96 mm based on at least one independent variable.

It is a further object of the invention to network a system of apparatus units that will optimize the quantity of droplets between 0.1 mm and 0.96 mm through selective activation and deactivation of individual apparatus units.

It is a further object of the invention to log activity of the apparatus, a remote environment and visitors to the apparatus for management of the area, the apparatus and to inform interested parties.

It is a further object of the invention to store power and to use predictive modelling in order to disperse droplets between 0.1 mm and 0.96 mm during times when the measurement of at least one independent variable may not be currently within a set range or when external power is not currently available.

It is a further object of the invention to permit deactivation on the approach of selective vehicles, watercraft or creatures.

It is a further object of the invention to disperse fluid to a distant region outside of the range where the fluid would otherwise flow or fall by gravity.

The citations are specifically incorporated herein by reference for all that the citations disclose and teach. Other objects, features, aspects and advantages of the present invention will become better understood or apparent from the following detailed descriptions, drawings and appended claims of the invention.

### BRIEF DESCRIPTION OF THE DRAWINGS

FIG. 1 shows a schematic depiction of an embodiment of the dispersion apparatus for controlled mist responsive to an environmental factor.

FIG. 2 shows an isolated depiction of the sensors, processing and control loop for water vapor pressure, water temperature and automatic adjustment of the pump nozzle, and shows a depiction of the solar panels, power converter and battery.

FIG. 3 shows an embodiment where multiple units are deployed around an ocean reef.

FIG. 4 shows a decision protocol for a system of multiple units similar to the embodiment as depicted in FIG. 3.

FIG. 5 shows a schematic depiction of an embodiment of the dispersion apparatus placed in the ocean adjacent to a golf course.

FIG. 6 shows a schematic depiction of an embodiment of the dispersion apparatus for placement in a birdbath.

### DESCRIPTION OF THE PREFERRED EMBODIMENT

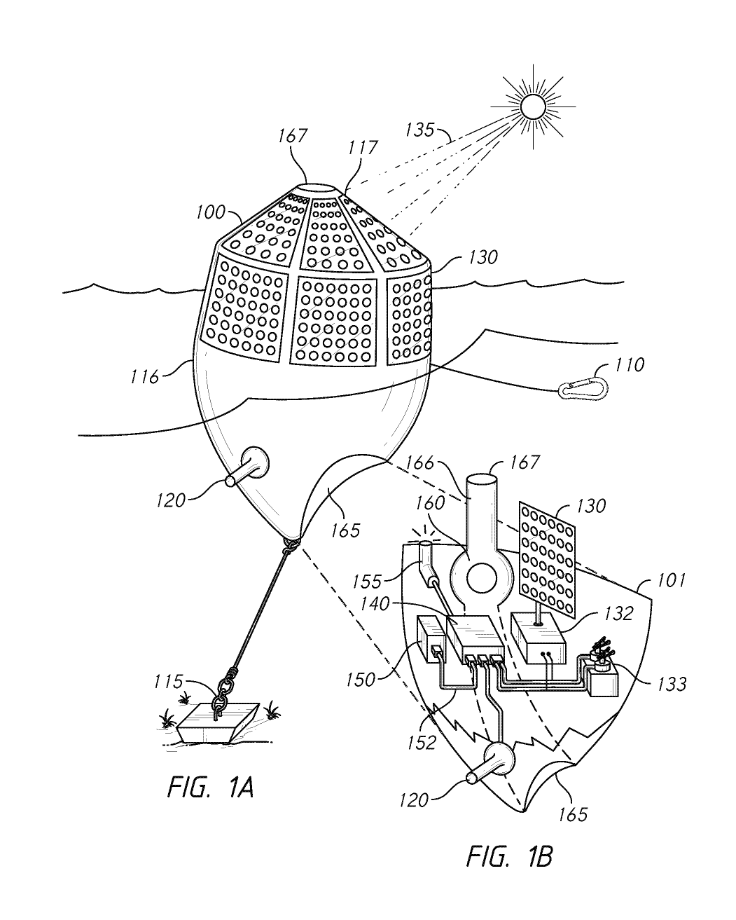

FIG. 1 shows a schematic depiction of an embodiment of the dispersion apparatus

for controlled mist responsive to an independent variable, with cross-section of internal components [101] in FIG. 1b. The apparatus [100] is a self-contained mooring buoy with mooring ring for boats [110], similar to the mooring buoy over an ocean coral reef, where scuba diving boats would moor during a dive visit. The buoy is tied by rope and anchor chain [115] to a fixed ring and weight embedded in the ocean floor, and by way of this tether the buoy will be fixed to this location and will remain generally in its intended upright position with the heavier balanced portion [116] below the waterline, regardless of wave and wake action. Despite the weight of the tether, the apparatus unit floats. Within the external housing of the buoy, below the waterline, is a sensor [120] that measures an independent variable, in this instance reading the external environmental factor of water temperature. An example of a common water temperature gauge would be model WD-93823-00 sold by Novatech International, produced by Oakton. The upper part of the external housing [117], above the waterline, is a clear, durable plastic, which permits sunlight [135] to enter and be absorbed by solar panel collectors [130]. The plastic housing is durable to withstand accidental impact from boats or other objects. Described in FIG. 1b, the exploded, cross-section view of internal components [101], the solar panels [130] are connected to power generating equipment [132] and to a battery [133] that will store power generated. The power generating equipment [132] provides power for a central processor [140] that powers the devices such as the sensor [120] and computer data storage device [150], for communications equipment [155], and for a water pump [160]. The buoy has an opening [165] in the bottom center that is an intake to a water pump [160] and is not open to the interior cavity of the buoy that contains solar panels [130], processor [140], data storage [150], communications equipment [155], device wiring [152] and power unit [132]. The sensor [120] for water temperature collects readings every 15 seconds and the data is processed by processor [140] and stored in the data storage device [150]. The solar panels [130] collect solar energy and the power unit [132] converts this to energy to maintain the battery [133] at full charge and to power the processor, which in turn powers the other devices such as the sensor [120]. In feeding the power unit [132], when the solar collection reaches a level that indicates sunlight has surpassed a minimum intensity or when the water temperature reaches a minimum level, then a signal is sent to the processor, which activates the pump [160] to start pumping. It is possible to use a separate light sensor to measure the amount of sunlight and act as trigger. Either variable will trigger the pump [160] to operate. When the pump [160] operates, it sucks sea water through the opening [165] in the bottom center of the buoy and trajects it in a center channel [166] out through the top opening [167] of the buoy into the air. The apparatus may have a screen of fine mesh over the opening [165] to protect the pump [160] from objects and to protect organisms from being sucked into the opening [165]. The apparatus may also use any variety of tripper rods near the opening [165] that interrupt the pump and delay its restart when such a rod is pushed or squeezed, to act as a safety mechanism from people or creatures near the pump [160]. Such a safety scheme could also be used on the outer rim of the buoy apparatus [100] at the waterline where a swimmer in distress could approach the buoy [100] and the buoy would shut off. The sensor [120] of the apparatus [100] continues to read and record water temperature every 15 seconds. While the water temperature remains above a set point and the solar collectors [130] transfer energy above a set point, the pump [160] continues to operate. As the water temperature rises or the solar collectors [130] transfer more energy, the pump [160] is accelerated to disperse more fluid into the air. When both the water temperature and the solar collection decrease below their set points, then the pump [160] will deactivate. The set points to deactivate the pump [160] may be below the initial activation points for both water temperature and solar collection.

In an alternate embodiment, the unit [100] is also in communication with a remote sensor to measure water temperature at the center of the reef, such sensors using wireless communications. In this embodiment, the unit may be directed by the processing of the temperature readings at the buoy but the unit [100] would also record readings at the reef to measure the effect of the fluid dispersion. There are a variety of methods to take readings and analyze results, including the differential gain in temperature at two different points or historically at two different points when a unit [100] is activated compared to when a unit [100] is not activated, and the example given here is not limiting of how such sensors may be deployed.

In an alternate embodiment, the unit [100] also includes a wind vane integrated with an anemometer to determine wind direction and speed. Readings of the wind direction over an interval for that day will be included to determine if the unit [100] is activated, so that fluid will be dispersed when the wind is expected to carry fluid over the target region, and the unit [100] will not be activated if wind is flowing in an alternate direction. It is possible that several such units [100] deployed in the same region but operating independently will result in dispersion by units [100] with a favorable wind direction but a dormant state of units [100] with an unfavorable wind direction.

In an alternate embodiment, the processor, data storage and sensors of the unit compare current readings and trend of readings for the most recent three hour period with historical patterns of three hour periods over recent days or similar calendar days from previous years, to determine a probability that the sunlight and temperature will proceed to a point of activation, what may commonly be referred to as a prediction the day “will be a hot one.” For such a prediction model, the unit may be programmed to activate the dispersion prior to the set points or at a set time of day, in advance of the predicted critical need so as to provide anticipatory shielding of sunlight that may help to reduce the later temperature extreme. In such an embodiment, it may be efficient to use battery power to operate the pump over a time period that power is draining from the battery faster than the solar panels are able to charge the battery, due to the current lower amount of sunlight.

The unit may utilize a pump, propeller, paddle, impeller, boiler, heating element, compression valve, bellows or pressure mechanism to achieve the trajectory, force, duration or pattern of fluid into the gas. The preferred embodiment uses a pump with rotating plastic impeller in a chamber to create water pressure in a chamber where the water can exit through a small aperture in the top. The result of this pressurized seawater through the small aperture is to traject the water to a height of at least 15 to 25 feet in the air. The height will assist to suspend droplets in the air for sufficient time before falling back to the sea. Alternate embodiments may employ more powerful pumps with higher trajectories and to determine if the empirical results are more effective.

In an alternate embodiment, the seawater to be dispersed may be heated by elements in the unit. The ability to integrate or combine heating units, or combinations of heating and cooling units, is not theorized here for the overall effect on the water temperature of the reef. There may a wide array of technologies for heating and cooling that differentially transfer heat from the water into the air, or transfer heat from an extreme part of the day to a less extreme period. A heating element, which is a typical feature added to some humidity dispersion devices, serves as an example for this embodiment of adding and integrating features. There are a variety of heating elements, boilers, compression valves and compression vacuum methods that could be employed to heat the seawater. Such heated water may be suspended longer in the gas and or with larger droplet size. This may be effective to carry the mist over a target range before the temperature of the fluid adjusts and the water returns quickly to the sea at a far boundary of the coral reef. Because fog and mist are more likely to naturally occur when air masses of differing temperatures collide, this heated mist will be more effective in certain ranges of water vapor pressure.

In an alternate embodiment, the external housing of the buoy above the waterline contains a sensor that reads water vapor pressure of the air. An example of a water vapor pressure gauge would be a Wide Angle High-Resolution Sky Imaging System (WAHRSIS), described by Soumyabrata Dev et al. to construct for approximately $2500 (US dollars). The specifications for this gauge show that readings in 15 second intervals can be smoothed by the computer to remove erroneous measurements due to wave foam or water. The apparatus also includes programming to interpret the readings of the water vapor pressure sensor and determine the favorable times when the water should be heated. The processor of the apparatus in this embodiment would send a signal to control equipment that would activate the heating elements during the favorable time period, and to the control equipment to deactivate the heating elements when conditions became unfavorable.

In an alternate embodiment, the apparatus includes an adjustable nozzle, as described in Zito et al.'s U.S. patent application Ser. No. 62104850. The U.S. patent application Ser. No. 62104850 is specifically incorporated herein by reference for all that it discloses and teaches. The processor of this alternate embodiment uses computer code to interpret sensor data and historical patterns to determine optimal nozzle aperture to integrate with other dispersion features to create a droplet size. The processor sends a signal to a controller that increases or decreases the aperture of the nozzle. This embodiment may alternatively also include a sensor for water vapor pressure. Adjusting the water droplet size to the water vapor pressure will maximize the amount of mist or fog that occurs from dispersion.

In an alternate embodiment, the apparatus includes communication equipment to send or receive signals to boats, stations, and other units or controllers. The processor may receive a signal from a station to override the control and activate the pump. The processor may receive a signal from an approaching boat to override the control and deactivate the pump. An alternate embodiment may include a compartment that can be opened by a button, containing an emergency aid kit and sending a signal to a remote station that an emergency has occurred, together with location or identification of the buoy, by number or by longitude and latitude or other ID system, to assist a rescue. The embodiment may include a dye pack that is activated together with the pump to disperse a colored mist into the air and would alert other people that an emergency has occurred. The embodiment may include visual and auditory signaling equipment, such as flares, whistles, sirens, lights or flags.

In an alternate embodiment, the unit [100] is generally flat on top, the girth forming a ring shape with a hole in the center where water is dispersed from the pump. The bottom is cone shaped with a cavity of sufficient space to contain the equipment needed, and to further balance the bottom for stability. The flat top surface permits more direct contact of the solar collector panels with sunlight, and for more even exposure throughout the day to gauge sunshine. However, it may also be an advantage of a cone shaped buoy that more solar collector panels will be exposed during hours when the sun is highest in the sky, and this will correspond to hours when sunlight penetrates directly through the top layer of the coral reef rather than having parts shielded by the three dimensional aspects of the reef formation. The ring of this embodiment is of sufficient width that a swimmer or diver could not easily reach from the outside to the pump opening, providing further safety and permitting use of pumps with greater than 1000 psi. The ring shape of this embodiment may have further advantages as a safety platform or emergency station for people in distress. The embodiment would include one section of the top surface, within reach of a normal person in the water and at the side, free of a solar panel and having a lid to a compartment of emergency equipment. Opening the lid of this compartment would send a signal to the processor to deactivate the pump and to further send a distress signal to a central station along with location, time, local water conditions and presence of a watercraft or more recent visit by watercraft, as examples. The embodiment demonstrates that a variety of shapes and designs of the unit construction are possible and the utility of the patent is not limited to this particular design described.

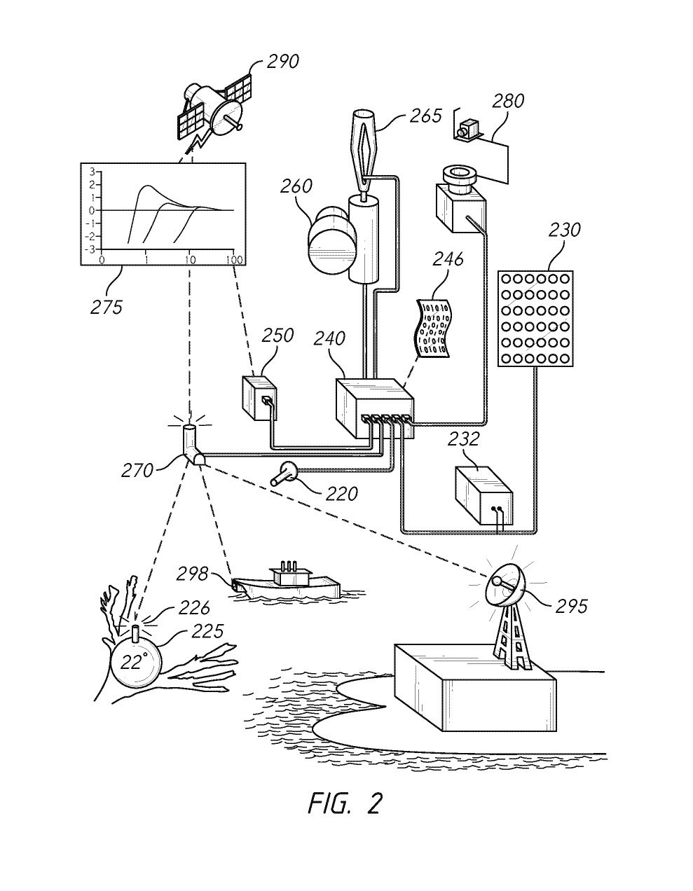

FIG. 2 shows an isolated depiction of the sensors, processing and control loop for a water vapor pressure gauge [280], water temperature gauge [220], remote temperature gauge [225] and automatic adjustment of the pump nozzle [265], and shows a depiction of a solar panel [230] and power converter [232]. A wide variety of water vapor pressure gauges are available, but in this example the measuring device shown is a Wide Angle High-Resolution Sky Imaging System (WAHRSIS), described by Soumyabrata Dev et al. to construct for approximately $2500(US dollars) as an example of a device to measure precipitable water. Measurements from the WAHRSIS are sent in regular intervals to the processor. The processor is also receiving signals from the water temperature sensor on the bottom of the buoy and from a remote water temperature sensor that has been placed in the reef. There are a variety of communication methods available for sensors, including direct line and wireless transmitter and receiver. In this example, the sensor [225] has been placed to provide a relatively unobstructed path for wireless communication, and the transmitter [226] uses a short range radio wave that is capable to reach the receiver [270] in the buoy apparatus. The remote sensor [225] measures and sends data at regular 15 second intervals.

The data is processed by the processor [240] using computer code [246] together with data from the data storage device [250] that includes prior measurements, historical data and predictive models. An example predictive model is based on Kohler curves [275] of supersaturation and salt particle diameter, correlation of saturation pressure and temperature, and Water Vapor Pressure from the gauge [280] and temperature from the local gauge [220] and remote gauge [225] to project the optimum seawater droplet size to disperse. The processor [240] uses computer code [246] to interpret the projected droplet size and send a signal to the nozzle controller [265], to increase or decrease the nozzle to the preferred aperture. The processor [240] also uses computer code [246] to interpret the current conditions of water temperature and water vapor pressure, and including the measurement of energy generated by the solar panels [230] through the power converter [232]. The measurement of energy from the solar panels is used here as a proxy measurement of sunlight. It is possible to include one or more of a variety of additional gauges to measure the amount of sunlight directly and send this data to the processor [240]. When measurements of the current conditions of water temperature, water vapor pressure and solar energy reach set points determined as fixed set points and adjusted by predictive models, the processor [240] then sends a signal to the pump [260] to activate. The processor creates a composite score for the measurements and adjusted set point based on historical patterns and predictive model. This composite score is recorded in the data storage unit with date and time and a log of the pump activity and nozzle aperture. The composite score is also used to adjust the rate of the pump [260]. As subsequent measurements are received, processed and interpreted with the historical data and predictive model into an adjusted composite score, the pump [260] is accelerated to deliver more water pressure and as a result more volume of water dispersed, or decelerated and as a result less volume of water dispersed. In this example, the nozzle aperture [265] is not adjusted to affect the volume of water dispersed but only to control the droplet size, and the pump speed is used to control the pressure and volume of water dispersed. It is possible to adjust both the nozzle aperture and the pump speed for water pressure together to optimize the effect of water dispersed.

Weather satellite [290] measurements are sent in a signal received by the apparatus receiver [270] and included in the compilation of data and predictive model for interpretation and determination of the composite score used to activate and adjust the pump and nozzle. The apparatus may use the advantage of local, low altitude and less expensive measurements directly from apparatus sensors with data received from external entities, for example high altitude and expensive measurements such as satellite-based spectroscopy, to deliver a more robust weather analysis, predictive model and resulting water dispersion. The results and collective log are sent by signal from the apparatus to a central land station [295] where the information assists to understand and predict weather patterns. The data could just as easily be sent to any number of external entities such as satellites, air or sea craft. A manager at the central land station [295] reviews more regional weather data and based on this broader perspective sends a signal to the apparatus receiver [270], interpreted by the processor [240], and the processor overrides the current programmed direction to send a signal to adjust the pump [260] and nozzle [265] for a prescribed period of time.

An approaching dive boat has an RFID tag [298] on the bow of the boat, which sends a signal to the buoy receiver [270] and the processor interprets the signal using computer code. The boat could just as easily transmit a special code or use any variety of signal systems to be received by the apparatus. Based on the processor interpretation of the signal from the boat, the processor sends a signal to the pump [260] to deactivate and the pump [260] will remain deactivated while the boat and RFID tag [298] remain within range. With the pump [260] deactivated, the boat is able to secure the buoy apparatus and tie on to the mooring line, stabilizing the boat in place during its dive visit. The processor [240] sends data to the data storage [250] that includes the identification number of the boat's RFID tag, the initial time of the visit, the activity of the pump [260] as it is deactivated, and the terminal time of the visit and the reactivation of the pump [260]. During the visit by the boat, the buoy apparatus continues to receive sensor measurements of water temperature, pH, salinity and sunlight and logs this data in the data storage.

The buoy could have an upper frame with solar panels that are fixed at an upper ring and swinging freely at the base of the panels, still above the water line. The panels may be at an angle sufficient to collect solar energy during hours when the sun is highest in the sky. At one side of a wave the frame could rock in one direction with the panels generally pointed skyward, and at an opposite side of the wave the frame could rock the other direction and keep the panels pointed skyward. The larger outer ring at the base of the panels permits the frame and panels to rock without interfering with the flow of water from the pump. A wide variety of systems exist to further adjust and angle solar panels for optimum receipt of sun energy, or to selectively favor and receive power from panels most directly in sunshine, and this should not be limiting to the methods possible.

The embodiment shows energy received by the solar panel [230] and transferred to a power conversion unit [232] that generates electricity. The electricity is distributed to the processor [240], which also powers the sensors [220] [280], data storage device [250] and communications equipment [270]. An alternative embodiment could use a heating element, the overall effect intended to heat the pumped water for easier production of fog. Power could be distributed from the power conversion unit [232] to the heating element and a signal sent from the processor [240] when the processor [240] determines that the heating element should be activated, based on the data of the sensors [220] [280], historical data, remote sensor data [225], predictive models [275] and any override codes from a central land station [295] or approaching vessels [298]. If a heating element is activated, water is heated instantaneously as it is pumped as “flash heating.” The purpose of the flash heating is to raise the temperature of water droplets and thereby permitting larger droplets to remain suspended longer until they cool, at which time they will drop faster than smaller drops. This method may keep the overall plume of fog suspended over a larger target zone longer and then said plume dropping more quickly at the far boundary of the target zone in return to the sea.

The embodiment also shows zinc blocks on the underside of the buoy. The buoy has generally been designed to expose only plastic and no metal on the external surfaces, and plastic tubing with plastic impeller inside the water pump. However, it is difficult to prevent exposure of all metal parts to the water, and furthermore boats with various exposed metal parts will tie to the buoy that has electrical charges within. If only for convenience, zinc blocks are placed on the underside to reduce galvanism, and there are a variety of other standard methods to reduce corrosion.

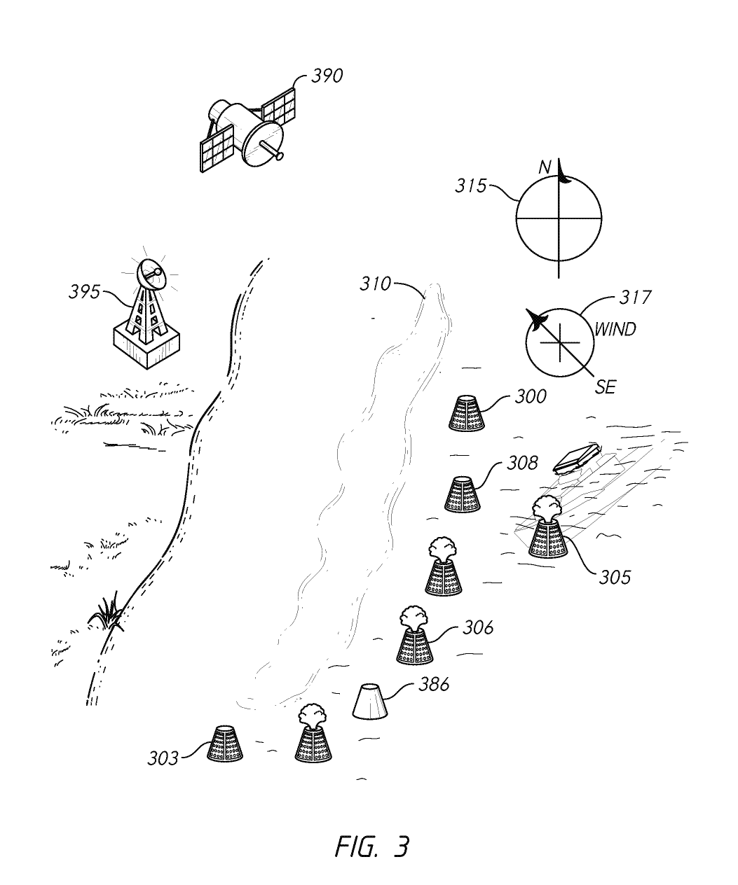

FIG. 3 shows an embodiment where multiple units [300] are deployed around an ocean reef [310]. A compass marking [315] and wind direction [317] are indicated on the drawing relative to the ocean reef [310]. Each of the units [300] is independently able to perform the functions described for example in FIG. 2. Each of the units [300] is able to receive signals from its own sensors, process signals together with computer code and historical data and predictive models retrieved from its data storage device and determine whether to activate or deactivate its pump and what adjustments, if any, to make to its nozzle aperture and speed of its pump to generate a target pressure. Each of the units [300] is able to determine this activation and deactivation as default if no signal or directive is received from an external entity, satellite [390], watercraft or person, central control station [395] or other units [300].

FIG. 3 also shows typical mooring buoys [386] that are not apparatus units, within a chart of all the apparatus units [300] and typical buoys [386]. The apparatus buoys [300] are each deployed with signal receivers and processing code to accept signals from approaching boats and interpret those signals to deactivate its pump. Boats are encouraged to pay membership dues for use of the apparatus buoys [300] and receive their individually identifying access code. Boats that choose not to join can access the public buoys [386]. Member boats can also access the public buoys [386] but will most likely access the member apparatus units [300] as these are placed closer to preferred dive locations. An example apparatus buoy [305] is over a highly attractive shipwreck where divers previously paid a visitation fee for the protected national park, and for which the park now carries a surcharge with each visit logged by the buoy [305] and signaled to the central station [395] to tally and email a monthly levy to each respective boat owner.

The design or layout of apparatus buoys [300] placed around the reef and southeasterly wind as indicated by the wind direction [317] and compass marking [315] are to indicate that the system of buoys [300] have been positioned to deliver the effect of the total plume for the most number of days over the most area of the reef. To do this requires knowledge of the prevailing wind patterns over the reef, which can be obtained from local historical records or from placing a few of the system buoys [300] in advance to collect environmental data before deploying the function of the pumps. According to the design, a wind vane on each apparatus buoy [300] will measure wind direction linked with an anemometer that will measure wind speed. The measurement for each buoy will be sent to its processor, along with water temperature at the buoy and from remote sensors submerged at the reef. It may be that the signal sent from submerged thermometers cannot be received by all buoys [300] in the region, due to various obstructions, but those buoys [300] that receive the signal will include the data in its processing, composite interpretations and overall data packet that the processors of the apparatus buoys [300] send by signal to the central station [395]. Each sensor, whether remote or attached to a buoy, can have an identifying number as part of its data packet, so that a remote sensor's measurement is not counted multiple times by the processor of the central station [395]. The processor of the central station [395] will log all measurements, identifying numbers and times to its data storage device, and this information will also be compared to previous measurements and activity of the buoys to determine any effectiveness of prior strategies employed. For example, if the water temperature declined or did not increase as much as would be predicted, then the strategy employed may be increased in a rating or the percentage odds that it should be employed in the future. The central station [395] receives the data from each of the apparatus buoys [300] and also receives data from weather satellite [390] readings of the area as well as predictive models for regional weather. A processor at the central station [395] compiles this data and determines a strategy for the system of apparatus buoys [300]. As an alternative, the processor may send a visual display of the measurements and rank order of strategies considered to a display screen where a manager can review the data and confirm or change the strategy selected. The direction of the apparatus or system can be further modified by signals created through interaction by a manager, operator, driver, or interested parties with the presentation or display. As an alternative, the processor may assign probabilities to the rank order of strategies, and may use a random number generator to select a second rank strategy or even a suboptimal strategy to test empirically the soundness of the processor's decision algorithms, so to further refine its predictive modelling. The processor will then proceed to employ its strategy selected, or alter the strategy and direction if a manager interrupts and commands the processor to do so. The central station then signals each of the apparatus buoys [300] with directions to the processor of each whether to activate its pump and at what speed and for what adjustment to its nozzle, or to deactivate its pump. The buoys [300] in the best strategic locations will be activated, while the buoys [303] in unfavorable locations will remain dormant. The overall effect is to generate a plume that can suspend and blow by the current wind at low altitude over the coral reef. At other times or days, the wind may be blowing in a different direction and at different speed, and the central station may determine a different strategy to activate different apparatus buoys [300] while leaving others inactive.

If the signal from a particular buoy [308] is not received by the central station [395], then the central station [395] will omit its presentation or interpolate its data from the nearest buoys to determine the best strategy. When the central station [395] sends a signal with directions to each of the apparatus buoys [300], each of the buoys [300] will process the signal, follow the directions and return a confirmation signal to the central station [395]. If the central station [395] does not receive a confirmation signal from a particular buoy [308] then the manager at the central station [395] may choose to wait a period of time to determine if the condition corrects, or may direct a member boat to visually observe any deviation to the buoy [308] that would interfere with signal transmission or reception.

As a member boat arrives at a buoy [305] and that buoy [305] deactivates its pump, that buoy [305] sends a signal to the central station [395]. The central station [395] may signal a neighboring buoy [306] to increase the speed of its pump to compensate temporarily for the absence of the buoy [305] used by the boat. The buoys [300] continue to monitor readings from their individual sensors and from remote sensors in the reef. The data for these readings are sent by signal to the central station [395], which processes the signals and stores data in a central data storage device. The entire set of data can be analyzed to determine effectiveness of the system to reduce water temperature and other factors for sun bleaching and refine predictive models of diel patterns for weather, water temperature, pH, salinity and other factors. On different days, the central station [395] processor can select secondary strategies that might have been predicted to be sub-optimal, to determine and analyze the effectiveness as compared to predicted results, historical results for optimal or comparable strategies, or theoretical estimates for what experts in the field may have projected, estimated or suggested. One strategy that can be tested is to predict water temperature in advance of the noon hour based on morning temperature readings, time of day, historical pattern and whether the pump operated within the past 24 hours. The objective of this strategy would be to test whether turning on the pump early, in advance of temperature extremes, is a more efficient method to mitigate the final temperature extreme for that day. Empirical studies have suggested that it is temperature extremes that are most lethal to coral formations, but the frequency and duration of non-lethal extremes correlates to resiliency of the coral, as though it can improve its chance of survival through acclimation to extremes. It is therefore an object of the system strategy to reduce the potentially lethal extreme temperatures while progressively permitting non-lethal extremes that can acclimate the coral to temperature fluctuations.

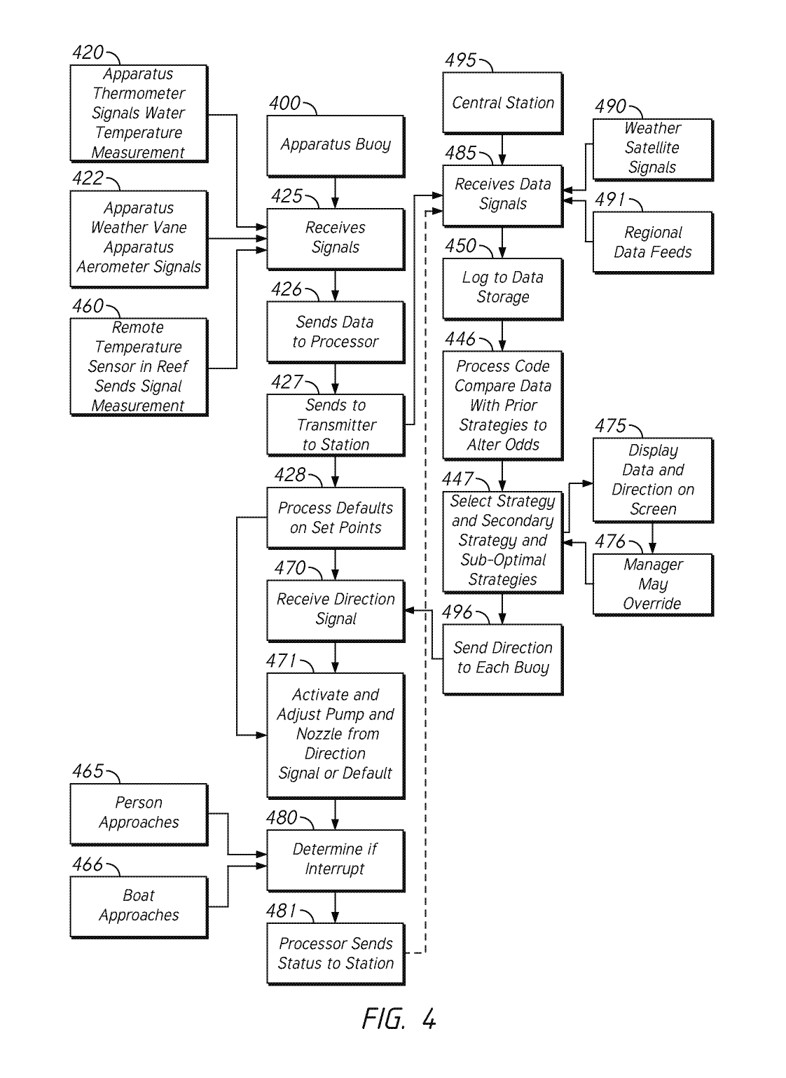

FIG. 4 shows a decision protocol for an alternative embodiment of the system depicted in FIG. 3, with the decision protocol for an individual buoy apparatus [400] embodiment as depicted in FIG. 2. If an individual buoy does not receive any signal from the central station [495] then the individual buoy apparatus [400] will default to its individual decision protocol.

In FIG. 4, the individual buoy apparatus [400] has a processor receiving signals [425] from attached sensors such as a water thermometer [420], wind vane and anemometer [422], water vapor pressure gauge or other sensors. The wind vane and anemometer [422] would indicate if the particular buoy apparatus [400] is in position to disperse fluid over the target area, for example. A water vapor pressure gauge would indicate how to adjust the nozzle aperture to optimize the droplet size to deliver the maximum fog or mist over the target area, for example. The individual buoy apparatus [400] also receives signals [425] sent from remote sensors such as a thermometer in the reef [460], and sends this group of data to its processor [426]. The processor sends this data packet to its transmitter to send [427] to the central station [495]. The processor also proceeds to process a default direction [428] by comparing the sensor measurements to set points.

The central station [495] receives data signals [485] from each individual buoy apparatus [400] and also receives signals [485] sent from weather satellite signals [490], regional data feeds by computer or internet [491] and other information sources. The processor logs this data to its center data storage device [450] and proceeds to process code [446]. In processing code [446], the processor pulls historical data from the data storage device, pulls prediction models and strategic algorithms and the current data for comparison. The processor can also compare current data with prior strategies to assign or alter odds or probabilities that it attaches to strategies as an indication of the success of that strategy, thereby refining its predictive models. From this processing [446], the processor will select a preferred strategy along with secondary strategies and sub-optimal strategies and even disadvantageous actions [447]. The processor may assign probabilities to the rank order of strategies, and may use a random number generator to select a second rank strategy or even a suboptimal strategy to test empirically the soundness of the processor's decision algorithms, so to further refine its predictive modelling. The processor of the central station [495] will display the data and rank order of strategies selected on a computer monitor or display screen for a manager's review [475]. The manager can choose to monitor or can intervene to override the strategy selected. The processor will then proceed to employ its strategy selected, or alter the strategy and direction if a manager interrupts and commands the processor to do so. The processor sends the direction for each individual apparatus buoy [400] by transmitter [496] to the receiver for each individual apparatus buoy [400], which receives its direction signal [470].

Each individual apparatus buoy [400] will activate or deactivate its pump and adjust its nozzle or any other actions [471] based on the direction received [470] from the central station [495], or based on its default selection based on set points [428] if no signal was received. If a person approaches [465] or an authorized boat approaches [466] within range to have a signal received, the processor of the individual apparatus buoy [400] processes an interrupt signal to halt the pump and ensure there is no interference or danger to the person or boat. The status of the individual apparatus buoy [400], in terms of pump, nozzle and other device functions, is transmitted [481] to the central station [495]. The information of the current status is received [485] by the central station [495] and merged with the continuous stream of data on sensor readings received [485] by the central station [495]. Therefore the loop of activity and measurements and processing of decision protocols is an ongoing process.

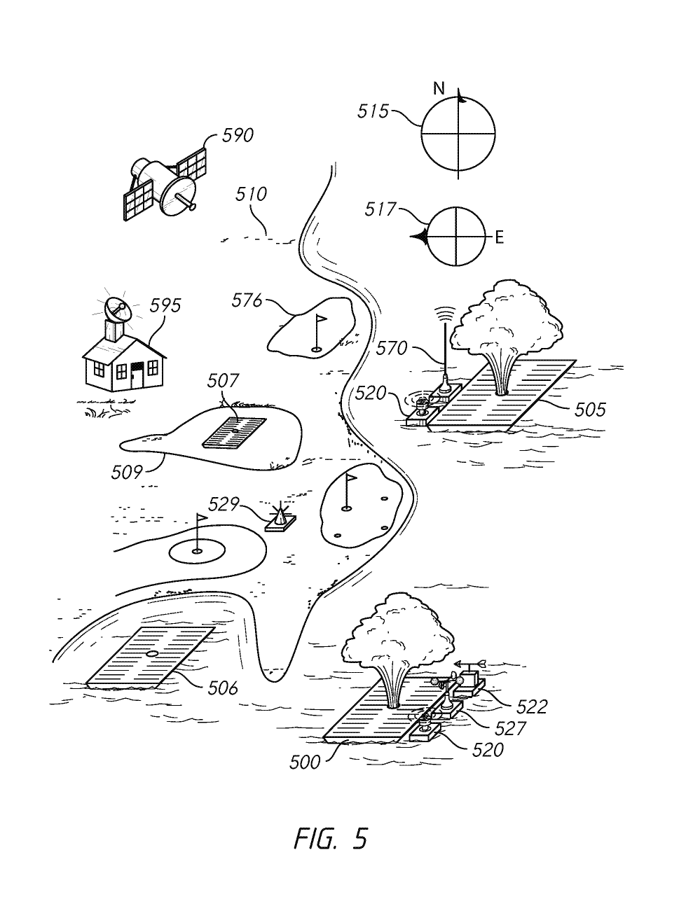

FIG. 5 shows a schematic depiction of an embodiment of the dispersion apparatus placed in the ocean adjacent to a golf course [510]. A compass marking [515] and wind direction [517] are indicated on the drawing relative to the golf course [510]. Each of the apparatus units [500] is independently able to perform the functions described for example in FIG. 2. Each of the units [500] is able to receive signals from its own sensors [520], process signals together with computer code and historical data and predictive models retrieved from its data storage device and determine whether to activate or deactivate its pump and what adjustments, if any, to make to its nozzle aperture and speed of its pump to generate a target pressure. Each of the units [500] is able to determine this activation and deactivation as default if no signal or directive is received from an external entity, watercraft or person, central control station [595] or other units [500].

In FIG. 5 the apparatus platforms [500] are each deployed with signal receivers [570] and processing code to accept signals from approaching boats authorized to manage or service the platforms [500] and the processor of each of the platforms [500] will interpret those signals to deactivate its pump. An example platform [505] is placed adjacent to a valuable “green” for the 9th hole [576] approaching the clubhouse. “Green” used here is the accepted golf term for the manicured area around the hole as opposed to an area of turf that just happens to have more green color than other areas of the golf course [510]. Another example platform [506] is placed at an extreme boundary to the south-southwest (SSW) of a major portion of the golf course [510] and to a retaining pond [509] on the course.

The design or layout of apparatus platforms [500] placed in the ocean around the golf course and easterly wind as indicated by the wind direction [517] and compass marking [515] are to indicate that the system of platforms [500] have been positioned to deliver the effect of the plumes for the most number of days over the most critical areas of the golf course [510]. To do this requires knowledge of the prevailing wind patterns over the golf course, which can be obtained from local historical records or from placing a few of the system platforms [500] or smaller apparatus buoys in advance to collect environmental data before deploying the function of the pumps. According to the design, the wind vane [522] on each apparatus platform [500] will measure wind direction and an anemometer [527] will measure wind speed. The measurement for each platform will be sent to its processor, along with water temperature at the platform and from remote sensors [529] in the soil at the golf course sent to the central control station [595] and then to the platforms [500], said remote sensors [529] equipped with above surface antennae. It may be that the signals sent from all remote sensors [529] cannot be received by the central control station [595] or that signals sent from the central control station [595] cannot be received by all platforms [500] in the region, due to various obstructions, but the central control station [595] will process its strategy based on the information it receives and transmit to platforms [500] that receive. The central station [595] receives the data from each of the apparatus platforms [500], from land-based sensors such as a soil-moisture gauge [529] and also receives data from regional weather information sources such as a computer data feed, satellites [590] or government internet reporting services for readings of the locale as well as predictive models for regional weather. A processor at the central station [595] compiles this data and determines composite interpretations and a best strategy for the system of apparatus platforms [500]. The central station [595] then signals each of the apparatus platforms [500] with directions to the processor of each whether to activate its pump and at what speed and for what adjustment to its nozzle, or to deactivate its pump. The platforms [500] in the best strategic location will be activated, while the platforms [500] in an unfavorable location will remain dormant. The strategy will account, at a minimum, for the wind direction and wind speed to ensure for each one of the apparatus platforms [500] directed to activate and adjust its pump and nozzle, that the fluid from that particular apparatus platform so directed is able to reach the golf course [510]. The overall effect is to generate a plume that can suspend and blow by the current wind at low altitude over the golf course. But more specifically, the grounds manager at this golf course is trying to deliver moisture to the most critical areas of the golf course [510] at times of day that will not impede play by patrons and that will supplement or subsidize the overall irrigation strategy for the golf course [510] and reduce the consumption of public water supplies. In the case of this example, with the easterly wind, the platform [505] is able to provide moisture to the 9th green [576] and reduce the overall requirement of public water supplies for that turf area. At other times or days, the wind may be blowing in a different direction and at different speed, and the central station may determine a different strategy to activate different apparatus platforms [500] while leaving others inactive. At other times or days, the wind may be from a SSW direction that makes it advantageous to activate a platform [506] that will provide moisture to other turf zones of the golf course [510] and may add water to the retaining pond [509].

If the signal from a particular platform [500] is not received by the central control station [595], then the central control station [595] will omit its data for the current processing interpretation or interpolate its data from the nearest platforms and historical comparison of platforms [500] to determine the best strategy. When the central control station [595] sends a signal with directions to each of the apparatus platforms [500], each of the platforms [500] will process the signal, follow the directions and return a confirmation signal to the central station [595]. If the central control station [595] does not receive a confirmation signal from a particular platform [500] then the manager at the central control station [595] may choose to wait a period of time to determine if the condition corrects, or may direct a maintenance worker to visually observe any deviation to the platform [500] that would interfere with signal transmission or reception, or visit the platform [500] by person or boat to further maintain the platform [500] and correct the deviation.

As an authorized boat or maintenance worker arrives at a platform [500] and presents the correct signal, that platform [500] will process the signal and deactivate its pump and send a signal to the central control station [595]. The platforms [500] continue to monitor readings from their individual sensors [520]. The data for these readings are sent by signal to the central control station [595], which processes the signals and stores data in a central data storage device. The entire set of data can be analyzed to determine effectiveness of the system to provide moisture to the golf course [510] and specific turf areas [576] and retaining pond [509] or other areas of interest. The entire set of data can also be analyzed to refine predictive models of diel patterns for weather, water temperature, soil moisture, soil pH, soil salinity or other factors. On different days, the central control station [595] processor can select secondary strategies that might have been predicted to be sub-optimal, to determine and analyze the effectiveness as compared to predicted results, historical results for optimal or comparable strategies, or theoretical estimates for what experts in the field may have projected, estimated or suggested. One strategy that can be tested is to predict soil moisture in advance of critical needs based on weather forecasts, current water supplies such as in the retaining pond [509], water consumption patterns such as percentage of annual water allotment or rationing already consumed, morning temperature and moisture readings, time of day, historical patterns and whether pumps for the platforms [500] operated within the past 48 hours. The objective of this strategy would be to test whether turning on the pumps of platforms [500] in advance of drought or dry periods without rain or in advance of temperature extremes, as a more efficient method to mitigate future water demands. It is therefore an object of the system strategy to reduce the overall water demands of the target area.

For a particular platform [505] the strategy may be to activate its pump prior to the 6 am time when players begin to enter the area. Solar energy is collected by the solar panels during the day and the power converted is stored in its battery. At 1 am of the next day the data is processed by the processor and by default or in connection and confirmation by the central control station [595], the pump is activated. The platform apparatus [505] continues to disperse mist for 5 hours, until 6 am as a set time that has been programmed or set by the central control station [595] to deactivate the pump. The agricultural requirements of turf are generally to provide moisture in pre-sunlight hours when moisture is most likely to fall to the soil as opposed to being lost to evaporation, but moisture will not linger on the plant when the sun rises, thereby reducing the potential of fungus or other turf health issues. By this method the system is delivering an optimum amount of moisture during a time most convenient to weather conditions including wind, to the agricultural requirements, and to overall strategies to reduce demands on the public water system.

For this example, the central control station [595] will use a strategy to activate the pump of the Southwest platform [506] during days when wind patterns are most advantageous. The example presented is for an area where prevailing winds would come from the SSW during an average of 5 days per month. Solar energy is collected by the solar panels during the day and the power converted is stored in its battery. When prevailing winds shift to SSW, the data is processed by the processor and by default or in connection and confirmation by the central control station [595], the pump is activated. The platform apparatus [506] continues to disperse mist as long as the SSW wind continues and power is sufficient to operate the pump. The pump will consume power from the battery and during daylight hours from the power converter drawing energy from the solar panels. It is possible to equip a platform in special positions such as platform [500] with a more powerful pump that would disperse a greater flow rate of moisture or operate for longer hours or days and may consume more power than would otherwise be available through a daily solar power conversion and battery storage scheme. For many batteries it is advantageous to use a majority of the electricity stored without draining the battery completely and so to condition the capacity of the battery to store charge and discharge. For this situation, the pump could operate until the battery is discharged to an optimum set point and power from the power converter directly from the solar panels is not otherwise available, at which point the pump would deactivate even if the weather conditions and water requirements are otherwise favorable. The pump in this situation would remain deactivated until such time that the solar energy converted has recharged the battery and provides power to the pump. It is possible that the solar energy converted will recharge the battery before providing power to the pump even though weather and water conditions are favorable to restart the pump, or may selectively restart the pump for a period of time or in balance with recharging the battery for instance where weather forecasts indicate that wind direction will only remain in the favorable direction for a limited amount of remaining time. It is possible to set a priority order of devices, sensors, communications or other parts consuming power in the platform [500] so that the processor can send code to deactivate parts consuming power and reserve power for the pump. For example, it is possible to reserve power only for the pump, processor, and communications to the central control station [595] and enabling the manager at the central control station [595] to direct the pump and maximize the operational duration of the pump according to the power available in the battery and from the solar power converter during daylight hours.

It is possible to situate an apparatus platform [500] where it can transfer moisture to a retaining pond [509] or other reservoir that is also collecting rain water. It is possible to operate the platform [500] during periods when wind and weather conditions are most favorable to maximize the quantity of water transferred to the retaining pond [509]. It is further possible to retain the water in the retaining pond [509] and place an additional buoy or platform [507] in the retaining pond that can disperse water from the retaining pond [509] to selective areas of the golf course [510] according to the most advantageous wind, weather conditions and needs of those selective areas. In this way it is possible to establish a step system of apparatus units [506] [507] that will transfer water from one location through another location to yet another location or locations with selective proportions.

It is possible to design the platforms [500] that they can be easily detached from their mooring locations, moved to more advantageous mooring locations, or to store during or in advance of the most adverse weather conditions. The design of the platforms [500] can include an easily accessible area to signal each platform to deactivate its pump, to detach the mooring line or replace the platform with a simple buoy, or detach a part of the platform that serves as a simple buoy to keep the mooring line in place and accessible when the platform is moved. In an alternate embodiment, the shape of the unit is optimized to move through a fluid and motor equipment is included in the unit for self-propulsion, to move the unit as it disperses fluid and thereby extend the range of dispersion. The design of the platforms [500] can be optimized for transport and storage. The sub-surface shape of the platform can be streamlined to optimize its movement through water if towed by a boat, or the outside rails and bottom of the platform can be designed to easily lift and place the platforms in a rack on a boat, or the top of the platform can also be designed to attach a cover and store the platforms in a rack within a building on land, as examples. The apparatus units may be optimized for lift and stowage in a rack, or otherwise permit cover or placement for storage. It is possible to collect and store the platforms in advance of gale, hurricane or other adverse conditions. It is possible to rotate a small number of platforms through a multitude of locations and optimize the quantity and rate of water delivered relative to the number of platforms deployed.

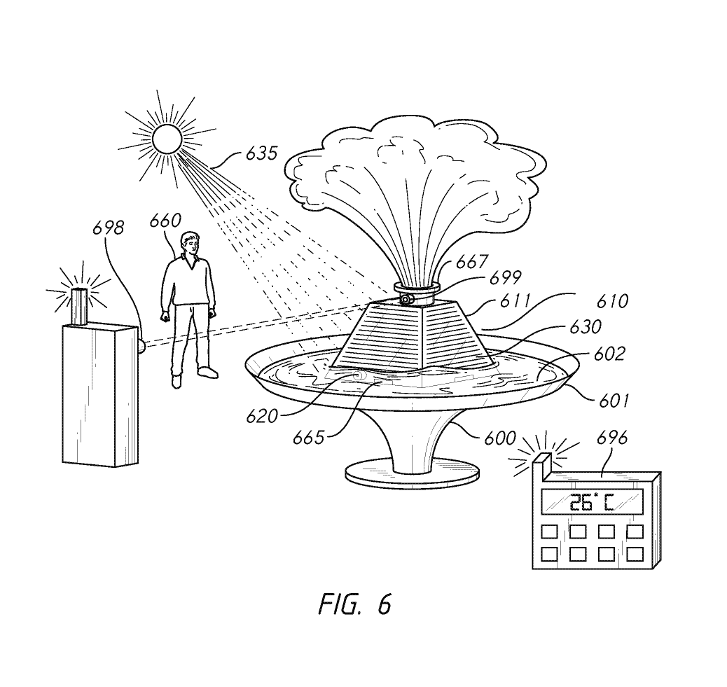

FIG. 6 shows a schematic depiction of an embodiment of the dispersion apparatus for placement in a birdbath [600]. The apparatus [610] is physically smaller than the apparatus described in other Drawings but provides the basic functionality for controlled mist responsive to an environmental factor. The apparatus [610] is a self-contained, water-tight and ornamental unit that can float or rest within the basin of the birdbath [600], preferably in the center on the bottom of the basin of the birdbath [600]. For the purposes of this example, the unit has been designed to appear as an artificial rock and the external shell of this unit will be referred to as the Rock [611], although the unit could be designed in any fashion and to appear as any number of various objects. Within the external housing of the Rock [611], below the waterline, is a sensor [620] that reads water level and ensures there is water sufficient to operate the pump. The upper part of the external housing of the Rock, above the waterline, is a clear, durable plastic, which permits sunlight [635] to enter and be absorbed by solar panel collectors [630] which are dark and make the overall appearance of the Rock to be dark. The plastic housing is durable to withstand accidental impact. The solar panels [630] are connected to power generating equipment that provides power to the sensor [620], and to a water pump. The Rock [611] has an opening [665] in the bottom that is an intake to a water pump and is not open to the interior cavity of the Rock [611] that contains solar panels [630], interior of the water level sensor [620], device wiring, power converter and mechanics of the pump. The solar panels [630] collect solar energy and the power conversion unit converts this to energy to power the sensor [620], and the water pump. It is possible to engineer the power converter to provide priority power through circuitry or by including a processor to devices such as the sensor before the pump but otherwise operate the pump as long as there is power sufficient to activate the pump, referred here as “on demand” operation. It is also possible through circuitry or by including a processor to prioritize power to devices such as the sensor [620] before the pump, but then only activate the pump when power is above a set point, so that the pump will only activate when sunlight is greater than a minimum intensity. The sensor [620] that reads water level will act as an interrupt that prevents the pump from activating if there is insufficient water in the basin to operate the pump. It is possible to engineer the circuitry for this interrupt function or to code a processor to accept an interrupt signal and execute directions to deactivate the pump when water level is too low and reactivate the pump when the water level rises above the minimum level. When the pump operates, it sucks water through the opening [665] in the bottom of the Rock [611] and trajects it in a center channel out through the top opening [667] of the Rock [611] into the air. The mist that is dispersed has the target droplet size described by this invention, and will result in some of the moisture being carried beyond the rim [601] of the basin, assuming that some wind is currently present even if no sensor for wind is included, but the droplet size also returning some of the moisture to the water in the basin [602] (not evaporated) and thus providing the right drizzle effect and prolonging the effect. The apparatus provides a controlled mist responsive to an environmental factor, in this example sunlight.

The object of FIG. 6 so far described is to generate mist of the target droplet size during the sunniest part of the day, providing an attraction to birds and disturbing the water to suppress breeding of mosquitoes.

In an alternate embodiment, a section of the upper part of the Rock [611] does not have a solar collector panel behind it but instead has a laser light receiver [699] that can be aligned with an external transmitter [698], in this example placed on the house by a door. It is also possible to place the transmitter within the Rock [611], to use a motion detector, auditory sensor or any variety of sensors and security features for a similar purpose that will be described. The power generating equipment provides power to the laser light receiver [600]. It is also possible through an external switch and circuitry or by including code for the processor to accept a signal where a person can turn the laser light transmitter on or off, or to select among any number of variable response functions as will be described here through an example function A and example function B.

Variable function A is here described as “homeowner proximity.” When the processor is set for A, and a person [660] interrupts the laser light beam from transmitter [698] to receiver [699], then a signal is sent to the processor, the processor will use code to interpret the signal and send a direction signal to deactivate the pump. It is an object of function A to interrupt the pump if the homeowner or a guest wants to approach the birdbath [600] without getting wet. If the homeowner or a guest desires to approach the birdbath and experience the drizzle, the person can simply approach from a direction that does not interrupt the laser light beam. It is possible to receive the laser light beam external to the Rock [611], such as at a receiver affixed to the house, and then have that receiver send a signal to the Rock [611] that is received by a separate receiver in the Rock [611] when the laser light beam is interrupted, and the final result of this signal sent to the Rock [611] is to interrupt the pump. The signal received by the Rock [611] can translate through circuitry, or transfer to a processor, or various other means to result in a signal that interrupts the pump. It is also possible to transmit the laser light beam externally, from the house, and receive the laser light beam at the Rock [611], then as the laser light beam is interrupted to indicate this event by transferring a signal directly within the Rock [611] via circuitry to deactivate the pump or to a processor that will process code and send a signal to deactivate the pump.

Variable function B is here described as “intruder proximity.” When the processor is set for B, and a person [660] interrupts the laser light beam from transmitter [698] to receiver [699], then a signal is sent to the processor, the processor will use code to interpret the signal and send a direction signal to activate the pump at maximum speed and pressure. It is an object of function B to override any minimum set points and activate the pump if any unknown person approaches the door as a deterrent. It is possible to receive the laser light beam external to the Rock [611], and then have that receiver [699] send a signal to a home security system controller [696], for the multitude of functions available, such as auditory alert, logging of activity or alert sent to a central monitoring station. It is possible to have the receiver [699] send a signal to the processor to send a signal directly to the pump or to have the security system controller [696] send a signal to the receiver [699] that can have the processor activate the pump at maximum, or omit any signal to the Rock [611] and have the function B act as a silent alarm. Alternatively, it is possible to have the laser light beam generated externally, from the house, and receive the laser light beam [699], then as the laser light beam is interrupted to indicate this event by transferring a signal directly from the Rock [611] to the home security system controller [696], while also activating the pump or to omit any signal change to the pump so that function B is a silent alarm.

It is possible to include with external receiver described in function A or B a steady state signal transmission with individually identifying information for the Rock [611] that the Rock [611] must receive or the pump will be interrupted and will not operate. If the Rock [611] is moved outside of the range of the steady state signal then the Rock [611] will become non-operational. It is an object of the steady state signal to deter theft of the Rock [611]. It is possible to deliver this result in any variety of configurations, such as transmitting a steady state signal from the Rock [611] to a home security system controller [696].

It is possible to include with the Rock [611] a switch, or a receiver to receive a signal that can interrupt the switching or processor to provide an on/off switch to the pump, or to change the set points for when the pump will activate. It is possible to integrate the transmission of the signals for this information into transmitters for function A or B as described, into a separate transmitter that is fixed or hand-held, or to integrate into existing processors and controllers such as home security systems, TV remotes, or computers, or to connect a transmitter to a computer to be controlled through the internet.

An alternate embodiment uses a different design and size of the Rock [611] so that it will fit any source of open water, such as a rain gutter, a spare tire, a puddle or the top of a roof. It is an object of the embodiment to provide a flexible apparatus that can be used and moved to suppress mosquito breeding.

An alternate embodiment changes the design to appear as a sprinkler head, and does not include solar panels or the circuitry to convert solar energy, but instead has a high powered pump connected to a public water supply, and the pump and wiring connected to a standard electric source and to a central controller or integrated with a home security system, irrigation system or similar controller. This embodiment does not include sensors for sunlight, soil moisture or natural conditions, but does include proximity indicators, motion detectors or any of the various intrusion detection devices. It is an object of this embodiment to activate a high powered pump that will disperse a wide area of heavy drizzle (droplets within the target size range), when an intruder has been detected in a target area, creating a deterrent to the intruder and alerting the homeowner or manager through the system controller or through the activation of the pump. It is possible to integrate automatic or controlled inclusion of substances, such as dye packs or other noxious substances, into the water flow to increase the deterrent or subsequent detection of intruders.

The descriptions contained herein of the specific embodiments reveal the general nature of the invention that others can, by applying knowledge within the skill of the art, readily modify and/or adapt for various applications of such specific embodiments, without undue experimentation and without departing from the general concept of the present invention. Therefore, such adaptation and modifications are intended to be within the meaning and range of equivalents of the disclosed embodiments, based on the teaching and guidance presented herein. It is understood that the phraseology or terminology herein is for the purpose of description and not of limitation, such that the terminology or phraseology of the present specification is to be interpreted by the skilled artisan in light of the teachings and guidance. While the foregoing has been set forth in considerable detail, it is to be understood that the drawings and detailed embodiments are presented for elucidation and not limitation. Design variations, especially in matters of shape, size and arrangements of parts may be made but are within the principles of the invention. Those skilled in the art will realize that such changes or modifications of the invention or combinations of elements, variations, equivalents or improvements therein are still within the scope of the invention as defined in the appended claims and their equivalents.

1-37. (canceled)

38. An apparatus, comprising:
a buoy;
a sensor to measure a change of an environmental event;
a nozzle mechanism mounted to the buoy, the nozzle operable to disperse a fluid; and
a control in communication with the sensor, the control operable to adjust the nozzle mechanism based on the environmental event.

39. The apparatus as recited in claim 38, further comprising a solar panel mounted to the buoy to power the sensor, the control and the nozzle mechanism.

40. The apparatus as recited in claim 38, wherein the sensor is connected to, but physically displaced from buoy.

41. The apparatus as recited in claim 40, wherein the sensor is displaced from where the fluid dispersed would fall by the force of gravity alone.

42. The apparatus as recited in claim 38, wherein the sensor is mounted to the buoy below a waterline.

43. The apparatus as recited in claim 38, wherein said fluid dispersed is of sufficient height and droplet size that at least 10% of the fluid falls to an area adjacent to the source fluid but where said fluid would not fall by force of gravity alone.

44. The apparatus as recited in claim 38, wherein the internal shape is adjustable such that a size of the aperture and an internal shape of the nozzle are adjustable to achieve a target range of droplet sizes for the fluid it disperses within a changing environment of temperature, pressure, and fluid density.

45. The apparatus of claim 38, where said fluid dispersed is of sufficient height and droplet size to reduce the amount of sunlight reaching the fluid surface within an area where at least 50% of the fluid falls.

46. The apparatus of claim 38 where said fluid is water or sea water and the environmental event is a change in sunlight, moisture, salinity, pH, wind or water current.

47. The apparatus of claim 38 where more than 30% of droplets of said fluid dispersed will remain suspended in a gas mixture for a time greater than would elapse if said droplets fell at terminal velocity by force of gravity but more than 30% of said droplets will return to the source of said fluid or an adjacent area and not remain suspended indefinitely if unimpeded.

48. The apparatus as recited in claim 38, wherein the environmental event includes at least one of sunlight, moisture, salinity, pH, wind or current.

49. The apparatus as recited in claim 38, wherein the average droplet size of said fluid dispersed is between 0.1 millimeters and 0.96 millimeters.

50. The apparatus as recited in claim 38, wherein the environmental event is at least one of natural phenomena that includes sunlight, wind, tide, wave, water current or earthquake.

51. A method to disperse a fluid from a buoy, comprising:
determining a change of an environmental event; and
adjusting a nozzle mechanism to spray sea water into the air as mist, where said system adjusts the spray automatically according to environmental conditions to maintain the spray as mist that will fall to the sea slower than rain drops but faster than a fog.

52. The method of claim 51, wherein a multiple of buoy apparatus is networked together to deliver a total effect over an area.
